(19) United States
(12) Patent Application Publication
(10) Pub. No.: US 2026/0196892 A1
(43) Pub. Date: Jul. 9, 2026

(54) ROTATING ELECTRIC MACHINE AND METHOD OF MANUFACTURING FIELD MAGNETON THEREOF

(71) Applicant: Mitsubishi Electric Corporation, Tokyo (JP)

(72) Inventors: Kengo KUMAGAI, Tokyo (JP); Shinsuke KAYANO, Tokyo (JP); Takeshi KUBOTA, Tokyo (JP)

(73) Assignee: Mitsubishi Electric Corporation, Tokyo (JP)

(21) Appl. No.: 19/552,707

(22) Filed: Feb. 27, 2026

Related U.S. Application Data
(62) Division of application No. 17/876,739, filed on Jul. 29, 2022, now abandoned.

(30) Foreign Application Priority Data
Mar. 7, 2022 (JP) 2022-034112

(51) Int. Cl. H02K 1/276; H01F 13/00; H02K 15/03

(52) U.S. Cl. CPC H02K 1/2773; H01F 13/003; H02K 1/276; H02K 15/03; H02K 2201/06

(57) ABSTRACT

Provided is a rotating electric machine, including: a field magneton; and an armature. In terms of components in a radial direction of the field magneton of magnetic fluxes passing from the field magneton to the armature, a magnetic flux density at a center in an axial direction of the field magneton is lower than a magnetic flux density at an end in the axial direction of the field magneton.

### CROSS-REFERENCE TO RELATED APPLICATION

This present application is a divisional of U.S. Application No. 17/876,739, filed on July 29, 2022, which is based on and claims priority under 35 U.S.C. §119 to Japanese Patent Application No. 2022-034112, filed on March 7, 2022, in the Japanese Intellectual Property Office, the disclosures of which are incorporated by reference herein in their entirety.

### BACKGROUND OF THE INVENTION

### 1. Field of the Invention

This disclosure relates to a rotating electric machine and a method of manufacturing a field magneton thereof.

### 2. Description of the Related Art

In a related-art motor, a plurality of pole pairs are included in a plurality of magnetic poles in a field magneton. Magnetic pole centers of a pair of magnetic poles included in each pole pair are shifted in directions opposite to each other in a circumferential direction so that a pitch angle of the magnetic pole centers does not match 360°/(number of magnetic poles). Further, magnetization ratios of the magnetic poles are set to be constant in the circumferential direction (see, for example, Japanese Patent Application Laid-open No. 2019-54696).

In the related-art motor as described above, the magnetization ratio in the circumferential direction is considered, but the magnetization ratio in an axial direction is not considered. Thus, electromagnetic force cannot be equalized in an axial direction of the field magneton.

### SUMMARY OF THE INVENTION

This disclosure has been made to solve the above-mentioned problem, and therefore has an object to provide a rotating electric machine and a method of manufacturing a field magneton thereof, with which electromagnetic force can be equalized in an axial direction of the field magneton.

According to at least one embodiment of this disclosure, there is provided a rotating electric machine including: a field magneton; and an armature, wherein, in terms of components in a radial direction of the field magneton of magnetic fluxes passing from the field magneton to the armature, a magnetic flux density at a center in an axial direction of the field magneton is lower than a magnetic flux density at an end in the axial direction of the field magneton.

According to the rotating electric machine and the method of manufacturing a field magneton thereof of this disclosure, electromagnetic force can be equalized in the axial direction of the field magneton.

### BRIEF DESCRIPTION OF THE DRAWINGS

FIG. 1 is a cross-sectional view of a rotating electric machine according to a first embodiment of this disclosure.

FIG. 2 is a half cross-sectional view of a field magneton of FIG. 1.

FIG. 3 is a graph for showing, by J-H curves, magnetic fields obtained when a magnet body of FIG. 2 is magnetized.

FIG. 4 is a cross-sectional view for illustrating a first step in a method of manufacturing a field magneton according to the first embodiment.

FIG. 5 is a cross-sectional view for illustrating a step following the step illustrated in FIG. 4.

FIG. 6 is a cross-sectional view for illustrating a step following the step illustrated in FIG. 5.

FIG. 7 is an explanatory view for illustrating magnetic field vectors in the step of FIG. 4.

FIG. 8 is an explanatory view for illustrating magnetic field vectors in the step of FIG. 5.

FIG. 9 is a graph for showing curves indicating hysteresis of a magnetic material.

FIG. 10 is a graph for showing a distribution of residual magnetic flux densities in the magnet body of FIG. 2.

FIG. 11 is a graph for showing distributions of magnetic flux densities at a tooth portion tip end of an armature core of FIG. 1.

FIG. 12 is a graph for showing, by a J-H curve, a method of magnetizing the magnet body in a modification example of the first embodiment.

FIG. 13 is a half cross-sectional view of a field magneton of a rotating electric machine according to a second embodiment of this disclosure.

FIG. 14 is a graph for showing a distribution of residual magnetic flux densities in a magnet body of FIG. 13.

FIG. 15 is a graph for showing an example of a distribution of residual magnetic flux densities that is different from FIG. 14.

FIG. 16 is a half cross-sectional view of a field magneton of a rotating electric machine according to a third embodiment of this disclosure.

FIG. 17 is a half cross-sectional view of a field magneton of a rotating electric machine according to a fourth embodiment of this disclosure.

FIG. 18 is a half cross-sectional view of a field magneton of a rotating electric machine according to a fifth embodiment of this disclosure.

FIG. 19 is a cross-sectional view taken along the line XIX-XIX of FIG. 18.

FIG. 20 is a cross-sectional view taken along the line XX-XX of FIG. 18.

### DESCRIPTION OF THE EMBODIMENTS

Now, embodiments of this disclosure are described with reference to the drawings.

### First Embodiment

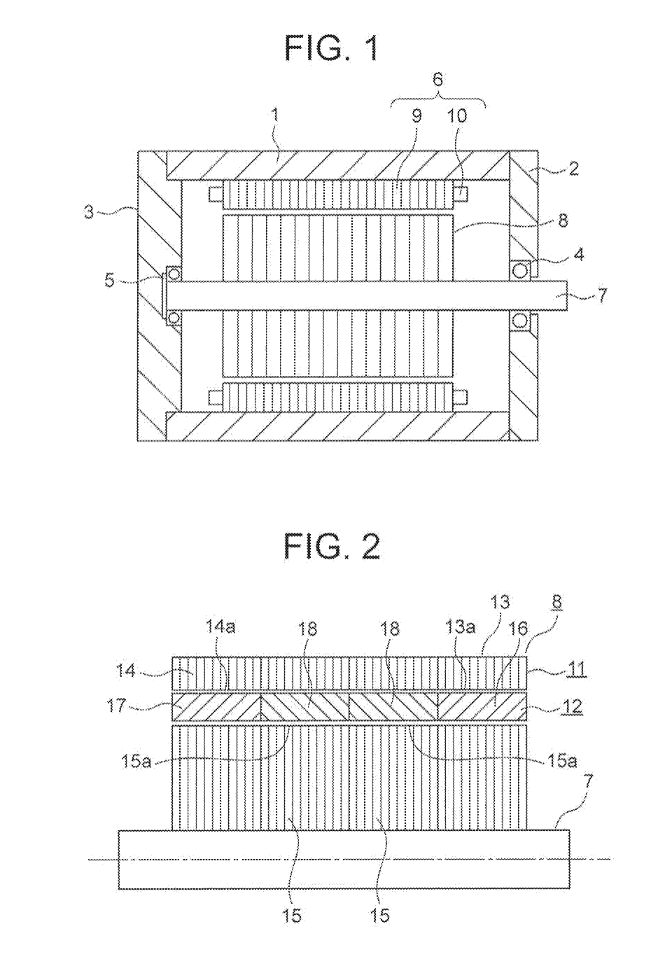

FIG. 1 is a cross-sectional view of a rotating electric machine according to a first embodiment of this disclosure. In FIG. 1, the rotating electric machine includes a housing 1 having a cylindrical shape, a first bracket 2 having a disc shape, a second bracket 3 having a disc shape, a first bearing 4, a second bearing 5, an armature 6 having a cylindrical shape, a rotary shaft 7, and a field magneton 8 having a cylindrical shape.

The first bracket 2 is fixed to a first end of the housing 1 in an axial direction of the rotating electric machine. The axial direction of the rotating electric machine is a direction along an axial center of the rotary shaft 7, and is a right-and-left direction of FIG. 1. The second bracket 3 is fixed to a second end of the housing 1 in the axial direction of the rotating electric machine.

The first bearing 4 is mounted to the first bracket 2. The second bearing 5 is mounted to the second bracket 3.

The armature 6 is fixed to an inner periphery of the housing 1. In other words, the armature 6 in the first embodiment is a stator. Further, the armature 6 includes an armature core 9 having a cylindrical shape and a plurality of armature coils 10.

The armature core 9 is formed by laminating a plurality of armature steel sheets in the axial direction of the rotating electric machine. Each armature steel sheet is an electromagnetic steel sheet. Further, the armature core 9 includes a yoke portion having a cylindrical shape and a plurality of tooth portions. Each tooth portion projects from the yoke portion toward an inner side in a radial direction of the rotating electric machine. The radial direction of the rotating electric machine is a direction orthogonal to the axial center of the rotary shaft 7. A slot is formed between each pair of adjacent tooth portions.

Each armature coil 10 includes a coil main portion and coil end portions. The coil main portion is inserted in a corresponding slot. The coil end portions protrude from ends of the armature core 9 in the axial direction of the rotating electric machine to the outside of the armature core 9.

The plurality of armature coils 10 are formed of one coil group or two or more coil groups. Each coil group includes a U-phase coil, a V-phase coil, and a W-phase coil. The number of phases is not necessarily limited to three. Each coil group is connected to an inverter (not shown).

The rotary shaft 7 is passed through the first bearing 4 and the second bearing 5. In other words, the rotary shaft 7 is rotatably supported by the first bracket 2 and the second bracket 3 via the first bearing 4 and the second bearing 5.

The field magneton 8 is fixed to the rotary shaft 7, and rotates integrally with the rotary shaft 7. In other words, the field magneton 8 in the first embodiment is a rotor. The rotary shaft 7 is passed through the center of the field magneton 8. An outer peripheral surface of the field magneton 8 is opposed to an inner peripheral surface of the armature 6 via a gap.

A rotation sensor (not shown) is provided on the first bracket 2 or the second bracket 3. The rotation sensor detects a rotation angle of the rotary shaft 7 and the field magneton 8. As the rotation sensor, for example, a resolver, an encoder, or a magnetoresistive (MR) sensor is used. An output signal from the rotation sensor is input to a controller (not shown).

FIG. 2 is a half cross-sectional view of the field magneton 8 of FIG. 1. The field magneton 8 has a field magneton core 11 having a cylindrical shape and a plurality of magnet bodies 12. FIG. 2 shows only one magnet body 12.

The field magneton core 11 is formed by laminating a plurality of field magneton steel sheets in the axial direction of the rotating electric machine. Each field magneton steel sheet is an electromagnetic steel sheet.

Further, the field magneton core 11 has a first end core block 13, a second end core block 14, and a plurality of center core blocks 15. In this example, two center core blocks 15 are used.

The first end core block 13 is arranged at a first end of the field magneton core 11 in an axial direction of the field magneton 8. The axial direction of the field magneton 8 is a direction parallel to the axial direction of the rotating electric machine, and is a right-and-left direction of FIG. 2. The second end core block 14 is arranged at a second end of the field magneton core 11 in the axial direction of the field magneton 8. The second end of the field magneton core 11 is an end on the side opposite to the first end of the field magneton core 11.

The plurality of center core blocks 15 are arranged at the center of the field magneton core 11 in the axial direction of the field magneton 8. In other words, the plurality of center core blocks 15 are arranged between the first end core block 13 and the second end core block 14.

A plurality of first insertion holes 13a are formed in the first end core block 13. FIG. 2 shows only one first insertion hole 13a. A plurality of second insertion holes 14a are formed in the second end core block 14. FIG. 2 shows only one second insertion hole 14a.

A plurality of third insertion holes 15a are formed in each center core block 15. FIG. 2 shows only one third insertion hole 15a for each center core block 15.

The plurality of magnet bodies 12 are provided in the field magneton core 11. Further, each magnet body 12 includes a first end magnet 16, a second end magnet 17, and a plurality of center magnets 18. In this example, two center magnets 18 are used for each magnet body 12.

Each first end magnet 16 is inserted in a corresponding first insertion hole 13a to be fixed to the first end core block 13. In this manner, each first end magnet 16 is arranged at a first end, which is an end in the axial direction of the field magneton 8.

Each second end magnet 17 is inserted in a corresponding second insertion hole 14a to be fixed to the second end core block 14. In this manner, each second end magnet 17 is arranged at a second end, which is an end in the axial direction of the field magneton 8.

Each center magnet 18 is inserted in a corresponding third insertion hole 15a to be fixed to a corresponding center core block 15. In this manner, each center magnet 18 is arranged on a center side in the axial direction of the field magneton 8 with respect to the first end magnet 16 and the second end magnet 17.

The field magneton 8 is skewed in a plurality of steps in the axial direction of the field magneton 8. In other words, the first end core block 13, the second end core block 14, and the plurality of center core blocks 15 are shifted by a certain skew angle in a circumferential direction of the field magneton 8. The circumferential direction of the field magneton 8 is a direction along a circular arc with its center being the axial center of the rotary shaft 7.

The skew angle is set so as to cancel out an order component of torque ripples that is desired to be reduced. Specifically, the skew angle is set in mechanical angle to:

360°/(number of poles)/(order component desired to be reduced).

In the first embodiment, the number of poles is 8, and the order component desired to be reduced is a 12th order component. Thus, the skew angle is set to 3.75°.

The skew angles of the second end core block 14, the two center core blocks 15, and the first end core block 13 are set to 0°, 3.75°, 3.75°, and 0°, respectively, so that arrangement of the skew angles is symmetric with respect to the center in the axial direction of the field magneton 8.

FIG. 2 shows a cross section of the field magneton 8 in a state of not being skewed.

In this example, a residual magnetic flux density of each center magnet 18 is lower than a residual magnetic flux density of the first end magnet 16, and is lower than a residual magnetic flux density of the second end magnet 17. As a result, a residual magnetic flux density of the magnet body 12 at the center in the axial direction of the field magneton 8 is lower than each of residual magnetic flux densities of the magnet body 12 at both ends in the axial direction of the field magneton 8.

As a result, in the rotating electric machine according to the first embodiment, in terms of components in a radial direction of the field magneton 8 of magnetic fluxes passing from the field magneton 8 to the armature 6, a magnetic flux density at the center in the axial direction of the field magneton 8 is lower than each of magnetic flux densities at ends in the axial direction of the field magneton 8. The radial direction of the field magneton 8 is a direction orthogonal to an axial center of the field magneton 8, that is, the axial center of the rotary shaft 7.

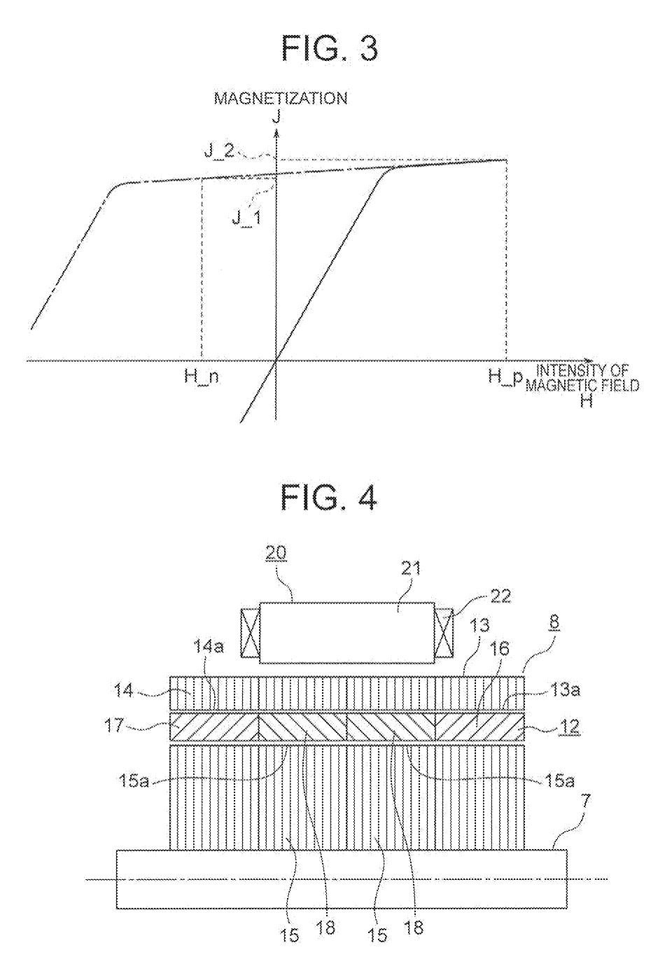

FIG. 3 is a graph for showing, by J-H curves, magnetic fields obtained when the magnet body 12 of FIG. 2 is magnetized. In FIG. 3, the vertical axis J represents an intensity of magnetization, and the horizontal axis H represents an intensity of the magnetic field. Further, the solid line of FIG. 3 indicates an initial magnetization curve. The one-dot chain line of FIG. 3 indicates a reverse magnetization curve.

Each of the first end magnet 16, the second end magnet 17, and the center magnets 18 is made of the same magnetic material, for example, Nd-Dy-Fe-B.

The first end magnet 16 and the second end magnet 17 are magnetized with an external magnetic field H_p. Meanwhile, the center magnets 18 are magnetized with the external magnetic field H_p, and are then slightly demagnetized with an external magnetic field H_n in an opposite direction. Also in a saturation region of magnetization, slight demagnetization occurs when the opposite magnetic field is applied.

As a result, an intensity of magnetization J_2 in the first end magnet 16 and the second end magnet 17 and an intensity of magnetization J_1 in the center magnets 18 have the following relationship: J_2>J_1. More specifically, the relationship is set, for example, as: J_1=0.94×J_2.

Next, description is given of a method of manufacturing the field magneton of the rotating electric machine according to the first embodiment. The method of manufacturing the field magneton according to the first embodiment includes an assembly step and a magnetization step.

The assembly step is a step of assembling the field magneton 8. In the assembly step, a plurality of unmagnetized magnet bodies 12 are mounted in the field magneton core 11. Specifically, a plurality of first end magnets 16 are mounted in the first end core block 13. Further, a plurality of second end magnets 17 are mounted in the second end core block 14. Still further, the plurality of center magnets 18 are mounted in each center core block 15.

Then, the first end core block 13, the plurality of center core blocks 15, and the second end core block 14 are coupled in an axial direction of the field magneton core 11 to assemble the field magneton 8.

The magnetization step is a step of magnetizing the plurality of magnet bodies 12 provided in the field magneton core 11. The magnetization step in the first embodiment includes a first step and a second step. The second step is performed after the first step.

The first step is a step of magnetizing each magnet body 12 at the center in the axial direction of the field magneton core 11. The second step is a step of magnetizing each magnet body 12 at the ends in the axial direction of the field magneton core 11. The axial direction of the field magneton core 11 is a direction parallel to the axial direction of the field magneton 8, and is the right-and-left direction of FIG. 2.

FIG. 4 is a cross-sectional view for illustrating the first step in the method of manufacturing the field magneton according to the first embodiment. A magnetizer 20 having a cylindrical shape is opposed to an outer peripheral surface of the field magneton core 11. The magnetizer 20 applies the external magnetic field to each magnet body 12.

Further, the magnetizer 20 includes a magnetizing core 21 and a plurality of magnetizing coils 22. The magnetizing coils 22 are connected to a DC power supply device (not shown).

A length of the magnetizing core 21 in the axial direction of the field magneton core 11 is shorter than an overall length of the field magneton core 11 in the axial direction of the field magneton core 11.

In the first step, the magnetizer 20 is opposed to the outer peripheral surface of the field magneton core 11 at the center in the axial direction of the field magneton core 11. Under this state, the magnetizing coils 22 are excited to magnetize each magnet body 12.

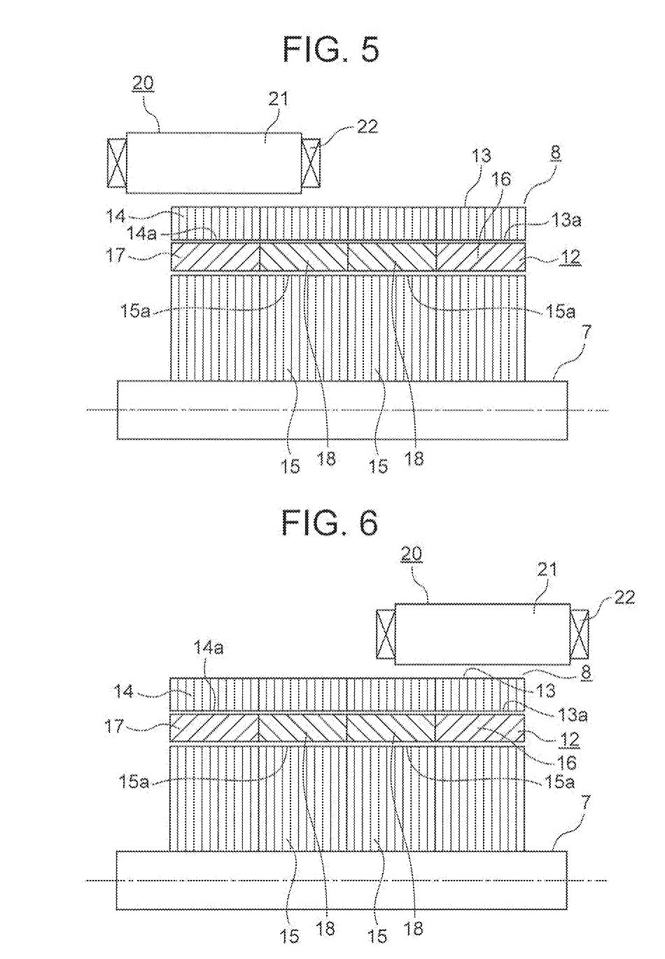

FIG. 5 is a cross-sectional view for illustrating a step following the step illustrated in FIG. 4, and shows a step forming the first half of the second step. FIG. 6 is a cross-sectional view for illustrating a step following the step illustrated in FIG. 5, and shows a step forming the second half of the second step.

After the first step, as illustrated in FIG. 5, the magnetizer 20 is moved in the axial direction of the field magneton core 11 relative to the field magneton core 11 so that the magnetizer 20 is opposed to the second end of the field magneton core 11. Under this state, the magnetizing coils 22 are excited to magnetize each magnet body 12.

After that, as illustrated in FIG. 6, the magnetizer 20 is moved in the axial direction of the field magneton core 11 relative to the field magneton core 11 so that the magnetizer 20 is opposed to the first end of the field magneton core 11. Under this state, the magnetizing coils 22 are excited to magnetize each magnet body 12. The step of FIG. 5 and the step of FIG. 6 may be performed in order reverse to that described above.

Through the above-mentioned magnetization process, the above-mentioned difference in residual magnetic flux density depending on the position in the axial direction of the field magneton core 11 can be imparted to each magnet body 12.

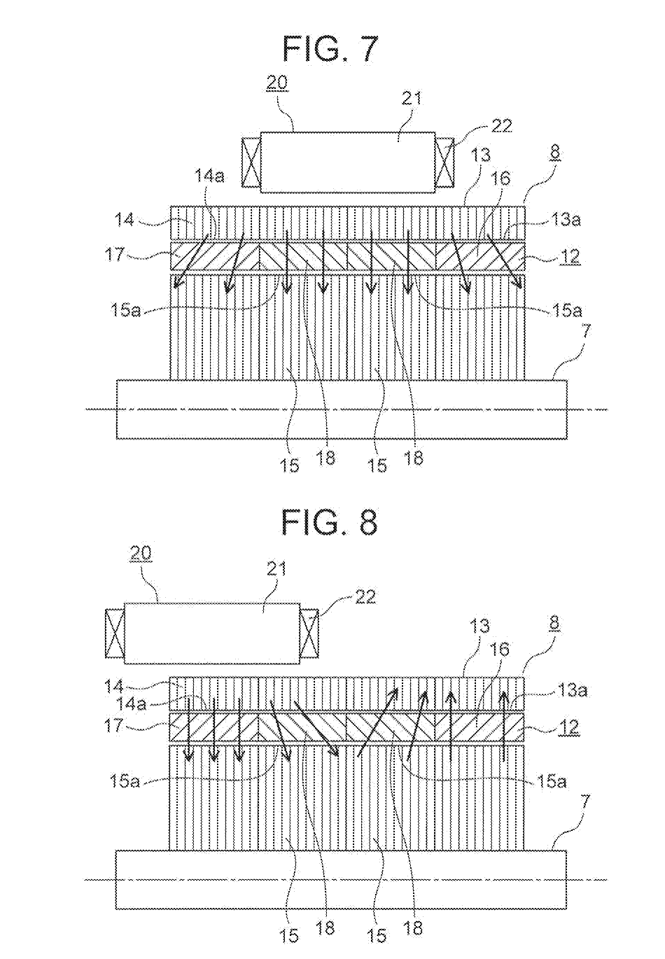

FIG. 7 is an explanatory view for illustrating magnetic field vectors in the step of FIG. 4. Similarly, FIG. 8 is an explanatory view for illustrating magnetic field vectors in the step of FIG. 5.

As illustrated in FIG. 7 and FIG. 8, at a position in the axial direction of the field magneton core 11 that is the same as a position of the magnetizer 20, the magnet body 12 receives magnetic fluxes along a desired direction of magnetization in design. However, as illustrated in FIG. 8, at a position in the axial direction of the field magneton core 11 that is apart from the position of the magnetizer 20, the magnet body 12 receives magnetic fluxes in a direction opposite to the desired direction of magnetization in design.

Further, when the magnetizer 20 is positioned at the center in the axial direction of the field magneton core 11 as illustrated in FIG. 7, the magnet body 12 is less likely to receive the magnetic fluxes in the opposite direction.

When the second step is performed after the first step as in the magnetization step in the first embodiment, the magnet body 12 first receives magnetic fluxes in directions illustrated in FIG. 7 in the first step. At this time, the first end magnet 16 and the second end magnet 17 are also slightly magnetized in the desired direction of magnetization in design.

Thus, even when the first end magnet 16 receives magnetic fluxes in the opposite direction illustrated in FIG. 8 after the first step, the first end magnet 16 is not magnetized in the opposite direction because of a hysteresis characteristic, and a high residual magnetic flux density can be obtained eventually.

In contrast, when the second step is performed before the first step, that is, when the step of FIG. 8 is performed before the step of FIG. 7, the first end magnet 16 is first magnetized in the opposite direction. In this case, the residual magnetic flux density in the first end magnet 16 is reduced because of the above-mentioned hysteresis characteristic, and the difference in residual magnetic flux density in the first embodiment cannot be imparted to each magnet body 12.

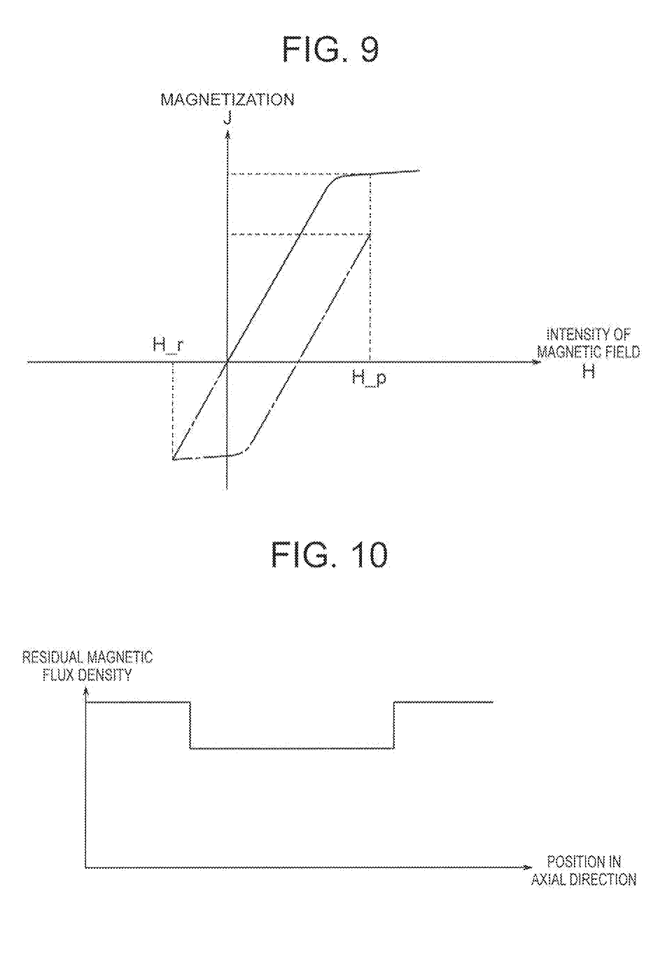

FIG. 9 shows curves indicating hysteresis of a magnetic material. Once magnetized with a magnetic field H_r in the opposite direction, the magnetic material becomes difficult to magnetize in the desired direction of magnetization in design because of the hysteresis characteristics. Thus, even when the magnetic material is subsequently magnetized with a magnetic field H_p, a value of magnetization becomes small as compared to the case in which the magnetic material is magnetized with the magnetic field H_p from the beginning.

FIG. 10 is a graph for showing a distribution of residual magnetic flux densities in the magnet body 12 of FIG. 2. In FIG. 10, the horizontal axis represents a position in the axial direction of the field magneton core 11. The vertical axis represents the residual magnetic flux density.

With the magnetization step in the first embodiment as described above, the distribution of residual magnetic flux densities as shown in FIG. 10 can be obtained.

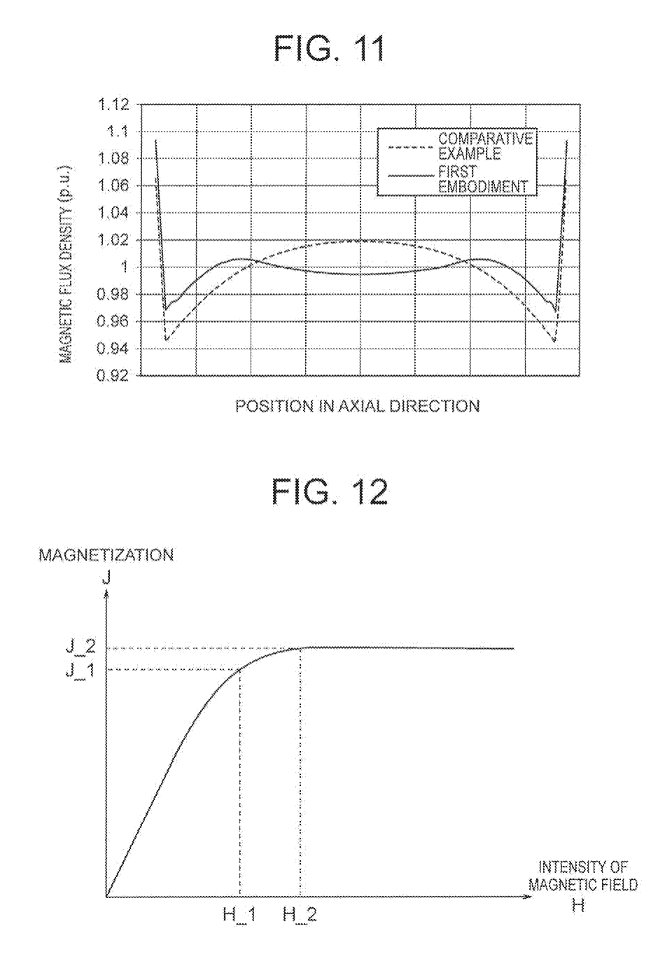

FIG. 11 is a graph for showing distributions of magnetic flux densities at a tooth portion tip end of the armature core 9 of FIG. 1, and shows magnetic flux densities obtained when the plurality of armature coils 10 are not energized. Further, in FIG. 11, the horizontal axis shows a position in the axial direction of the rotating electric machine. The vertical axis represents a magnetic flux density.

Further, the solid line indicates a distribution of magnetic flux densities in a case in which the field magneton 8 in the first embodiment is used. The dotted line indicates a distribution of magnetic flux densities in a case in which a field magneton in a comparative example is used. With the field magneton in the comparative example, the residual magnetic flux densities of the magnet body are the same over the axial direction of the field magneton core. Further, for each of the first embodiment and the comparative example, the magnetic flux densities are shown with an average of magnetic flux densities being 1 p.u.

As shown in FIG. 11, in the case in which the field magneton in the comparative example is used, an uneven distribution of magnetic flux densities is seen in the axial direction of the rotating electric machine. This is because magnetic flux leakage occurs in air regions at ends of the armature 6.

Accordingly, in the case in which the field magneton in the comparative example is used, for example, cogging torque generated by the first end core block is smaller than cogging torque generated by the center core block adjacent to the first end core block.

In contrast, in the case in which the field magneton 8 in the first embodiment is used, as compared to the case in which the field magneton in the comparative example is used, the magnetic flux densities can be equalized. As a result, for example, cogging torque generated by the first end core block 13 and cogging torque generated by the center core block 15 adjacent to the first end core block 13 become equal to each other. In addition, both components of cogging torque cancel each other because of the skew.

Consequently, with the use of the field magneton core 11 in the first embodiment, cogging torque of the order intended at the time of design can be further reduced.

In this example, when cogging torque of the 12th order component of torque ripples at the time of not being energized was compared among the first embodiment, Comparative Example 1, and Comparative Example 2, the following result was obtained. The following comparison result is numerical values obtained when Comparative Example 1 was set as 100%.

Comparative Example 1: 100.0%

Comparative Example 2: 93.5%

First embodiment: 88.4%

In Comparative Example 1, the magnet body is magnetized to J_2 over the axial direction of the field magneton core. In Comparative Example 2, the magnet body is magnetized to J_2×0.97 over the axial direction of the field magneton core. In this case, J_2×0.97 is an average value of magnetization of the magnet body 12 in the first embodiment.

As described above, in the first embodiment, cogging torque is smaller than those in Comparative Example 1 and Comparative Example 2. In particular, in the first embodiment, the cogging torque is smaller than that in Comparative Example 2, and hence it is understood that the configuration of the first embodiment is effective even with the same average of residual magnetic flux densities.

In the rotating electric machine as described above, in terms of components in the radial direction of the field magneton 8 of magnetic fluxes passing from the field magneton 8 to the armature 6, a magnetic flux density at the center in the axial direction of the field magneton 8 is lower than each of magnetic flux densities at the ends in the axial direction of the field magneton 8. As a result, the magnetic flux densities received by the armature 6 can be equalized in the axial direction of the rotating electric machine, and electromagnetic force can be equalized in the axial direction of the field magneton 8.

Further, the residual magnetic flux density of the magnet body 12 at the center in the axial direction of the field magneton 8 is lower than each of the residual magnetic flux densities of the magnet body 12 at both ends in the axial direction of the field magneton 8. Thus, a magnetic flux density at the center in the axial direction of the field magneton 8 can be made lower than each of magnetic flux densities at the ends in the axial direction of the field magneton 8.

Still further, the residual magnetic flux density of each center magnet 18 is lower than the residual magnetic flux density of the first end magnet 16, and is lower than the residual magnetic flux density of the second end magnet 17. As a result, the field magneton 8 can be skewed in the plurality of steps while making the magnetic flux density at the center in the axial direction of the field magneton 8 lower than each of the magnetic flux densities at the ends in the axial direction of the field magneton 8.

In addition, the field magneton 8 is skewed in the plurality of steps in the axial direction of the field magneton 8. Consequently, the cogging torque can be reduced.

Further, in the method of manufacturing the field magneton according to the first embodiment, after the first step of magnetizing the magnet body 12 at the center in the axial direction of the field magneton core 11, the second step of magnetizing the magnet body 12 at the ends in the axial direction of the field magneton core 11 is performed. Thus, the residual magnetic flux density of the magnet body 12 at the center in the axial direction of the field magneton 8 can be made lower than each of the residual magnetic flux densities of the magnet body 12 at both ends in the axial direction of the field magneton 8. In this manner, the electromagnetic force can be equalized in the axial direction of the field magneton 8.

Still further, the magnetization step is divided into the first step and the second step, and hence the length of the magnetizing core 21 in the axial direction of the field magneton core 11 can be made shorter than the overall length of the field magneton core 11 in the axial direction of the field magneton core 11. In this manner, a capacity of the DC power supply device can be reduced.

### Modification Example

Now, a modification example of the first embodiment is described. In the modification example, the first end magnet 16, the second end magnet 17, and each center magnet 18 are mounted in the field magneton core 11 after being magnetized. Further, in magnetizing each center magnet 18, an ampere turn of the magnetizer 20 is set larger than that in magnetizing the first end magnet 16 and the second end magnet 17. In this manner, a distribution of residual magnetic flux densities similar to that in the first embodiment can be obtained.

FIG. 12 is a graph for showing, by a J-H curve, a method of magnetizing the magnet body 12 in the modification example of the first embodiment. In FIG. 12, the vertical axis J represents an intensity of magnetization, and the horizontal axis H represents an intensity of a magnetic field.

Each of the first end magnet 16, the second end magnet 17, and the center magnets 18 is made of the same magnetic material, for example, Nd-Dy-Fe-B.

In the modification example, each center magnet 18 is magnetized with a magnetization magnetic field H_1, which is lower than a saturation magnetization magnetic field. In contrast, the first end magnet 16 and the second end magnet 17 are magnetized with a magnetization magnetic field H_2, which is stronger than the magnetization magnetic field for the center magnets 18.

Consequently, a residual magnetic flux density of each center magnet 18 is lower than a residual magnetic flux density of the first end magnet 16, and is lower than a residual magnetic flux density of the second end magnet 17. Thus, each of a magnetic flux density generated by the first end magnet 16 and a magnetic flux density generated by the second end magnet 17 is higher than a magnetic flux density generated by each center magnet 18.

More specifically, each of a value of magnetization of the first end magnet 16 and a value of magnetization of the second end magnet 17 is J_2, and is equal to a saturation magnetization value. In contrast, a value of magnetization of the center magnets 18 is J_1 and is set as J_1=0.94×J_2, for example.

Also with the modification example as described above, effects similar to those obtained with the rotating electric machine according to the first embodiment can be obtained.

### Second Embodiment

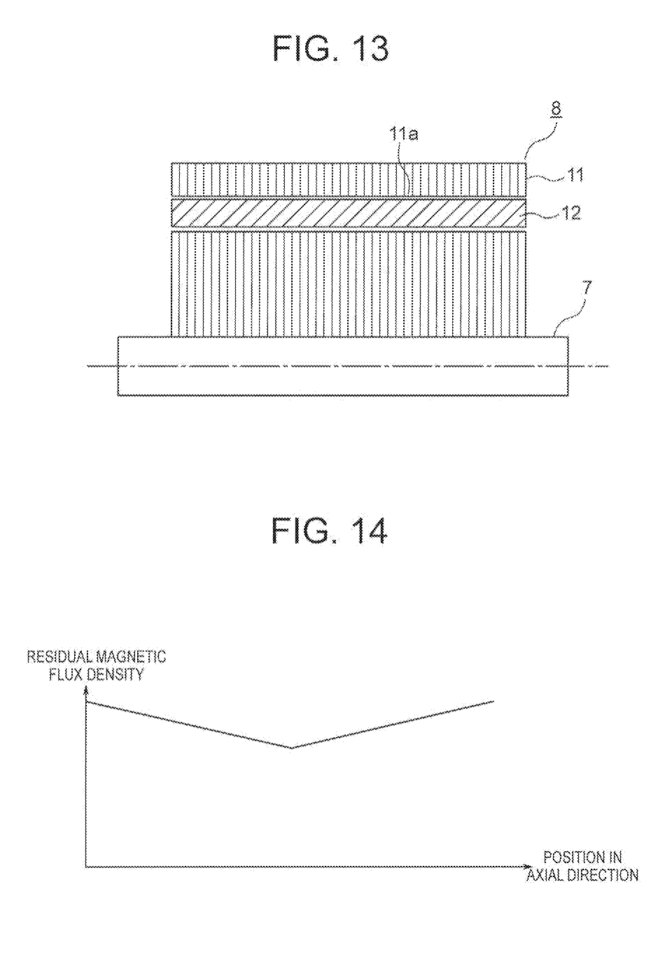

Next, FIG. 13 is a half cross-sectional view of a field magneton 8 of a rotating electric machine according to a second embodiment of this disclosure. FIG. 14 is a graph for showing a distribution of residual magnetic flux densities in a magnet body 12 of FIG. 13.

A field magneton core 11 in the second embodiment is not divided into a plurality of core blocks in the axial direction of the field magneton 8. In the field magneton core 11, a plurality of insertion holes 11a are formed. Further, each magnet body 12 is not divided in the axial direction of the field magneton 8, and is formed of one magnet that is continuous in the axial direction of the field magneton 8. In addition, each magnet body 12 is inserted in a corresponding insertion hole 11a. Further, the field magneton 8 is not skewed.

As shown in FIG. 14, a residual magnetic flux density of the magnet body 12 at the center in the axial direction of the field magneton 8 is lower than each of residual magnetic flux densities of the magnet body 12 at both ends in the axial direction of the field magneton 8.

The other configurations in the second embodiment are similar or identical to those in the first embodiment.

Also with the configuration as described above, the electromagnetic force can be equalized in the axial direction of the field magneton 8.

Further, forces generated in the armature 6 and the field magneton 8 become symmetrical in the axial direction of the rotating electric machine. In this manner, vibrations and noise can be reduced.

Still further, the configuration in the second embodiment is effective also when magnetic flux densities received by the armature 6 become lower at a center in the axial direction of the rotating electric machine. In other words, at both ends in the axial direction of the field magneton 8, because of heat transfer by convection, heat can be transported to the first bracket 2 and the second bracket 3, and hence good heat dissipation property is obtained as compared to that at the center in the axial direction of the field magneton 8. For that reason, distribution of occurrence of core loss is advantageous in terms of heat when concentrated at both ends in the axial direction. From this viewpoint, it is preferred that the magnetic flux densities received by the armature 6 be lower at the center in the axial direction, and be higher at both ends in the axial direction.

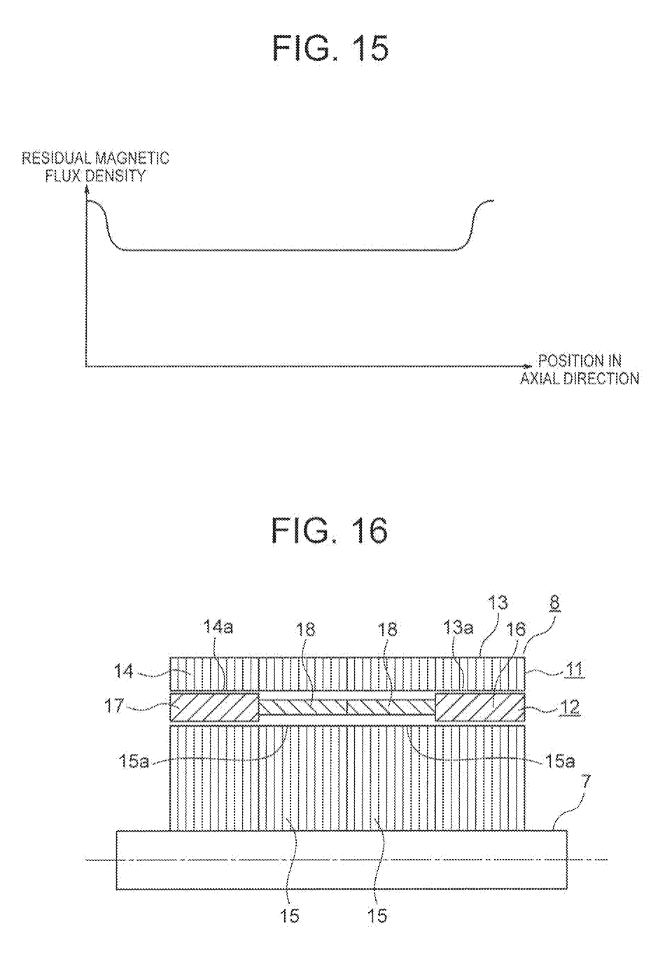

In FIG. 14, the distribution of residual magnetic flux densities changes with a constant gradient. However, it is not always required that the distribution of residual magnetic flux densities change with a constant gradient, and the residual magnetic flux densities may increase abruptly at both ends in the axial direction of the field magneton 8 as in FIG. 15, for example.

### Third Embodiment

Next, FIG. 16 is a half cross-sectional view of a field magneton 8 of a rotating electric machine according to a third embodiment of this disclosure. In the third embodiment, a thickness dimension of each center magnet 18 in the radial direction of the field magneton 8 is smaller than a thickness dimension of the first end magnet 16 in the radial direction of the field magneton 8, and is smaller than a thickness dimension of the second end magnet 17 in the radial direction of the field magneton 8.

Consequently, a volume of each center magnet 18 is smaller than a volume of the first end magnet 16, and is smaller than a volume of the second end magnet 17. Further, in each third insertion hole 15a, a space adjacent to the center magnet 18 in the radial direction of the field magneton 8 is formed.

The other configurations in the third embodiment are similar or identical to those in the first embodiment.

With the above-mentioned configuration, with the space being formed in each third insertion hole 15a, a magnetic resistance in each center core block 15 is higher than a magnetic resistance in the first end core block 13, and is higher than a magnetic resistance in the second end core block 14.

Consequently, a total magnetic flux amount per unit length is different between the center in the axial direction of the field magneton 8 and both ends in the axial direction of the field magneton 8. In other words, of magnetic fluxes passing from the field magneton 8 to the armature 6, a magnetic flux density at the center in the axial direction of the field magneton 8 is lower than each of magnetic flux densities at both ends in the axial direction of the field magneton 8. Thus, effects similar to those obtained in the first embodiment can be obtained.

Further, in the third embodiment, when a magnetization step is performed before an assembly step, the residual magnetic flux density in each of the first end magnet 16, the second end magnet 17, and each center magnet 18 can take a value of a saturation region. As a result, it is no more required to strictly manage a magnetizing current and the like in the magnetization step.

Further, the first insertion hole 13a, the second insertion hole 14a, and the third insertion hole 15a may be of the same size, and hence the first end core block 13, the second end core block 14, and the center core blocks 15 can be manufactured by using a common manufacturing facility.

### Fourth Embodiment

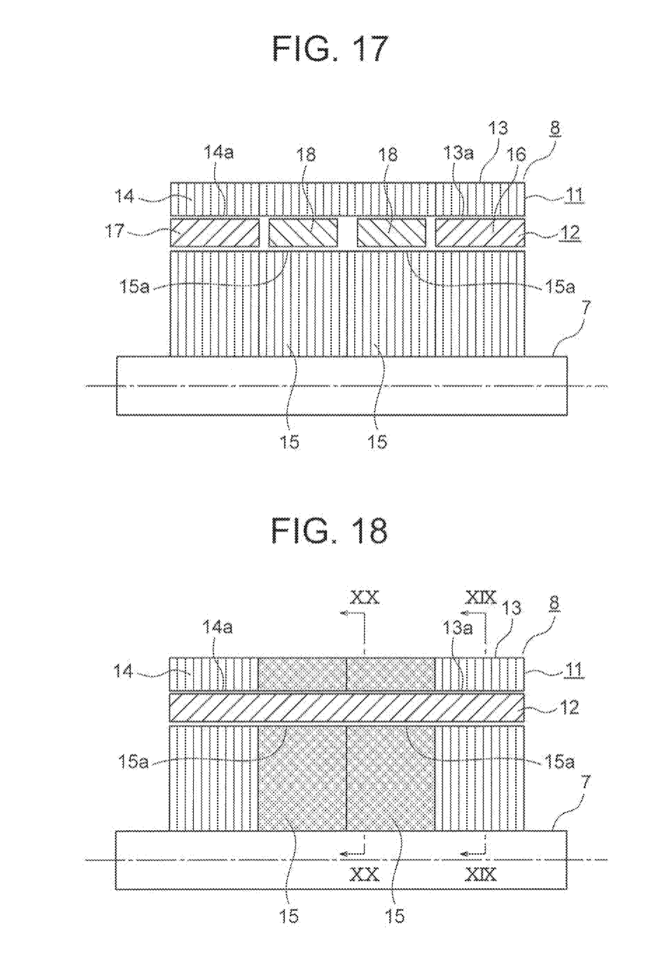

Next, FIG. 17 is a half cross-sectional view of a field magneton 8 of a rotating electric machine according to a fourth embodiment of this disclosure. In the fourth embodiment, a length dimension of each center magnet 18 in the axial direction of the field magneton 8 is smaller than a length dimension of a first end magnet 16 in the axial direction of the field magneton 8, and is smaller than a length dimension of a second end magnet 17 in the axial direction of the field magneton 8.

Consequently, a volume of each center magnet 18 is smaller than a volume of the first end magnet 16, and is smaller than a volume of the second end magnet 17. Further, in each third insertion hole 15a, a space adjacent to the center magnet 18 in the axial direction of the field magneton 8 is formed.

The other configurations in the fourth embodiment are similar or identical to those in the first embodiment.

Also with the configuration as described above, effects similar to those obtained in the third embodiment can be obtained.

In order to make the volume of the center magnet 18 smaller than the volume of the first end magnet 16, for example, it is only required to make a dimension of the center magnet 18 smaller than a dimension of the first end magnet 16 in at least one of the axial direction, the radial direction, and the circumferential direction of the field magneton 8. The same applies to a case in which a shape of each of the first end magnet 16, the second end magnet 17, and the center magnet 18 is not a rectangular parallelepiped.

Further, a volume of each center magnet 18 in the first embodiment may be made smaller than each of a volume of the first end magnet 16 and a volume of the second end magnet 17.

Still further, when each magnet body 12 is not divided in the axial direction of the field magneton 8 as in the second embodiment, a cross-sectional area of the magnet body 12 at the center in the axial direction of the field magneton 8 may be made smaller than each of cross-sectional areas of the magnet body 12 at both ends in the axial direction of the field magneton 8.

### Fifth Embodiment

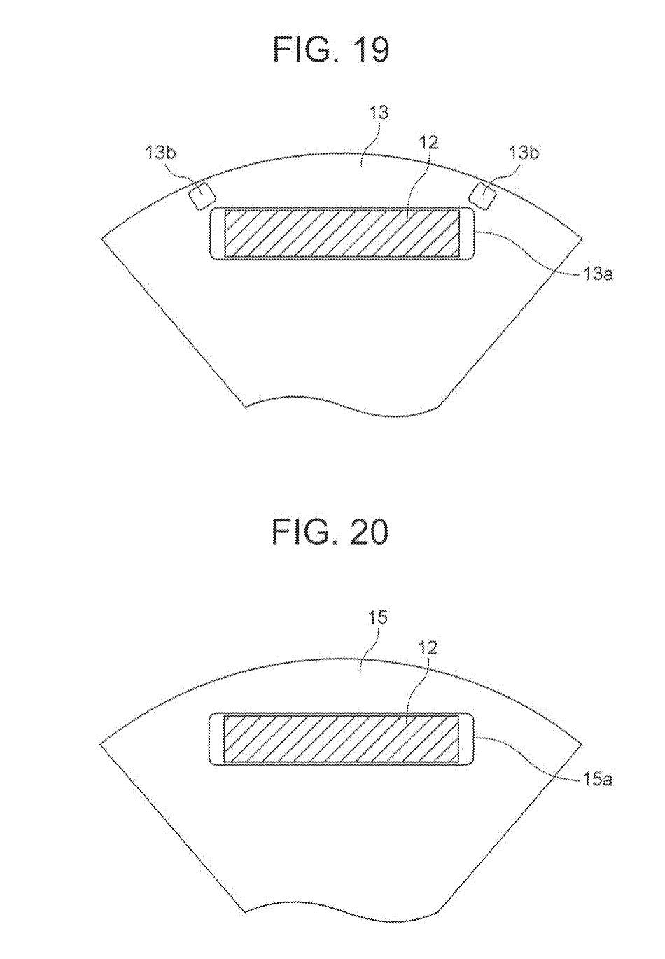

Next, FIG. 18 is a half cross-sectional view of a field magneton 8 of a rotating electric machine according to a fifth embodiment of this disclosure. FIG. 19 is a cross-sectional view taken along the line XIX-XIX of FIG. 18. FIG. 20 is a cross-sectional view taken along the line XX-XX of FIG. 18.

In the fifth embodiment, a cross section of a first end core block 13 that is taken orthogonal to the axial center of the field magneton 8 is different from a cross section of a center core block 15 that is taken orthogonal to the axial center of the field magneton 8. A cross section of a second end core block 14 that is taken orthogonal to the axial center of the field magneton 8 is the same as the cross section of the first end core block 13 that is taken orthogonal to the axial center of the field magneton 8.

Specifically, as illustrated in FIG. 19, a pair of flux barriers 13b are provided in the first end core block 13. The pair of flux barriers 13b are located on an outer side in the radial direction of the field magneton 8 with respect to both ends of a first insertion hole 13a in the circumferential direction of the field magneton 8.

Each flux barrier 13b is formed of a material having a magnetic resistance that is higher than that of the first end core block 13 itself, for example, air. When each flux barrier 13b is formed of air, each flux barrier 13b is an opening formed in the first end core block 13.

In contrast, as illustrated in FIG. 20, the pair of flux barriers 13b are not provided in each center core block 15. Further, as in the second embodiment, a magnet body 12 is not divided in the axial direction of the field magneton 8. Still further, the magnet body 12 is equally magnetized over the axial direction of the field magneton 8.

The other configurations in the fifth embodiment are similar or identical to those in the second embodiment.

With the above-mentioned configuration, magnetic fluxes that are short-circuited in the first end core block 13, and magnetic fluxes that are short-circuited in the second end core block 14 become smaller than magnetic fluxes that are short-circuited in the center core blocks 15.

Accordingly, in terms of magnetic fluxes passing from the field magneton 8 to the armature 6, a magnetic flux density at the center in the axial direction of the field magneton 8 is lower than each of magnetic flux densities at both ends in the axial direction of the field magneton 8. As a result, the magnetic flux densities received by the armature 6 can be equalized in the axial direction of the rotating electric machine, and electromagnetic force can be equalized in the axial direction of the field magneton 8.

In the first to fourth embodiments, as described in the fifth embodiment, a cross section of the field magneton core 11 may be made different depending on the position in the axial direction of the field magneton 8.

Further, in the first to fifth embodiments, the number of magnet bodies 12 is not particularly limited.

Still further, in the first, third, fourth, and fifth embodiments, the number of center core blocks 15 may be one or three or more.

Yet further, when each magnet body 12 is divided in the axial direction of the field magneton 8, the number of center magnets 18 included in each magnet body 12 may be one or three or more.

Yet further, in the first to fifth embodiments, the magnet body 12 is formed to be symmetric with respect to the center being the center in the axial direction of the field magneton 8, but may be asymmetric. For example, a magnetic flux density at one end in the axial direction of the field magneton 8 may be higher than the magnetic flux density at the center in the axial direction of the field magneton 8, and a magnetic flux density at the other end in the axial direction of the field magneton 8 may be equal to the magnetic flux density at the center in the axial direction of the field magneton 8.

Yet further, in the first to fifth embodiments, the field magneton 8 is a rotor. However, the field magneton may be a stator.

Yet further, each magnet body 12 may be fixed to the outer peripheral surface of the field magneton core 11. For example, the rotating electric machine may be a permanent magnet synchronous motor of a surface magnet type.

Yet further, the rotating electric machine may be a rotating electric machine of a field magneton winding type, for example, a synchronous motor or a DC motor. In other words, the magnet body may be an electromagnet.

Yet further, the rotating electric machine may be a power generator.

What is claimed is:

1. A method of manufacturing a field magneton of a rotating electric machine, the method comprising a magnetization step of magnetizing a magnet body provided to a field magneton core,
wherein the magnetization step includes:
a first step of magnetizing the magnet body at a center in an axial direction of the field magneton core; and
a second step of magnetizing the magnet body at an end in the axial direction of the field magneton core, and
wherein the second step is performed after the first step.

2. The method of manufacturing a field magneton of a rotating electric machine according to claim 1,
wherein the magnet body at the end in the axial direction has a first end portion and a second end portion located on opposite sides of the magnet body at the center in the axial direction,
wherein the second step includes a first half step and a second half step performed after the first half step,
wherein the first half step is magnetizing the magnet body at one end portion of the first end portion and the second end portion,
wherein the second half step is magnetizing the magnet body at the other end portion of the first end portion and the second end portion.

3. The method of manufacturing a field magneton of a rotating electric machine according to claim 1,
wherein in the magnetization step, magnetization is performed in a state where a magnetizer having a magnetizing core whose a length in the axial direction is shorter than the entire length in the axial direction of the field magneton core is opposed to an outer peripheral surface of the field magneton core.

4. The method of manufacturing a field magneton of a rotating electric machine according to claim 3,
wherein the magnet body at the end in the axial direction has a first end portion and a second end portion located on opposite sides of the magnet body at the center in the axial direction,
wherein in the second step, magnetization is performed at one end portion of the first end portion and the second end portion in a state where the magnetizer is opposed to the outer peripheral surface of the field magneton core, at that time, the other end portion of the first end portion and the second end portion receives magnetic fluxes in a direction opposite to a direction of magnetic fluxes received by the field magneton core at the one end portion.

5. A rotating electric machine manufactured by the method of manufacturing a field magneton of a rotating electric machine according to claim 1, comprising:
a field magneton; and
an armature,
wherein, in terms of components in a radial direction of the field magneton of magnetic fluxes passing from the field magneton to the armature, a magnetic flux density at a center in an axial direction of the field magneton is lower than a magnetic flux density at an end in the axial direction of the field magneton.

6. The rotating electric machine according to claim 5,
wherein the field magneton includes:
a field magneton core; and
a magnet body provided to the field magneton core, and
wherein a residual magnetic flux density of the magnet body at the center in the axial direction of the field magneton is lower than a residual magnetic flux density of the magnet body at the end in the axial direction of the field magneton.

7. The rotating electric machine according to claim 6,
wherein the magnet body includes:
an end magnet arranged at the end in the axial direction of the field magneton; and
a center magnet arranged on the center side in the axial direction of the field magneton with respect to the end magnets, and
wherein a residual magnetic flux density of the center magnet is lower than a residual magnetic flux density of the end magnet.

8. The rotating electric machine according to claim 5,
wherein the field magneton includes:
a field magneton core; and
a magnet body provided to the field magneton core,
wherein the magnet body includes:
an end magnet arranged at the end in the axial direction of the field magneton; and
a center magnet arranged on the center side in the axial direction of the field magneton with respect to the end magnet, and
wherein a volume of the center magnet is smaller than a volume of the end magnet.

9. The rotating electric machine according to claim 5,
wherein the field magneton includes:
a field magneton core; and
a magnet body provided to the field magneton core,
wherein the field magneton core includes:
an end core block arranged at the end in the axial direction of the field magneton; and
a center core block arranged on the center side in the axial direction of the field magneton with respect to the end core block, and
wherein a cross section of the end core blocks that is taken orthogonal to an axial center of the field magneton is different from a cross section of the center core block that is taken orthogonal to the axial center of the field magneton.

10. The rotating electric machine according to claim 5, wherein the field magneton is skewed in a plurality of steps in the axial direction of the field magneton.
